(19) United States
(12) Patent Application Publication
(10) Pub. No.: US 2007/0025110 A1
(43) Pub. Date: Feb. 1, 2007

(54) Adjustable lamp socket and mounting assembly

(75) Inventors: Damon H. Langlois, Victoria (CA); James A. Anderson, Brentwood Bay (CA); Donald A. Cleland, Langford (CA); David Gates, Victoria (CA)

Correspondence Address: LAW OFFICES OF CHARLES W. BETHARDS, LLP, P.O. BOX 1622, COLLEYVILLE, TX, 76034, US

(73) Assignee: Streetlight Intelligence, Inc.

(21) Appl. No.: 11/378,595

(22) Filed: Mar. 17, 2006

Related U.S. Application Data
(60) Provisional application No. 60/703,838, filed on Jul. 29, 2005.

(51) Int. Cl. F21S 8/00

(52) U.S. Cl. 362/427

(57) ABSTRACT

A mounting assembly (100) for a lamp socket (105) that is adjustable, comprises a bracket (101) configured to be mechanically coupled to a luminaire assembly and a mounting plate (103) configured to attach to the lamp socket and be mechanically coupled to the bracket and selectively engage the bracket at one of a multiplicity of angular rotations. A corresponding method of aligning a lamp to a desired rotational position with respect to a luminaire, includes disengaging a mounting plate from a bracket, where the mounting plate and the bracket are coupled about a common axis of rotation, rotating the mounting plate about the axis to a rotational position corresponding to the desired rotational position of the lamp and re-engaging the mounting plate and the bracket.

### FIELD OF THE INVENTION

This invention relates in general to lighting fixtures and more specifically to an adjustable lamp socket and mounting assembly, and using the mounting assembly for the rotational alignment of a lamp and socket within a luminaire.

### BACKGROUND OF THE INVENTION

High intensity discharge (HID) lighting is prevalent in our society. It is used for both interior and exterior applications where improved visibility is required. For interior applications, HID luminaries can be found in sports arenas, warehouses, industrial plants, office and other commercial lighting situations. For exterior applications, HID luminaries are used to illuminate roadways, parking areas, sports fields, signs, buildings, and the like. Often, a luminaire containing a HID lamp is placed several meters off the ground, and access for installation and maintenance purposes is via an overhead lift or bucket truck.

HID lamps and luminaries are manufactured according to IESNA (Illuminating Engineering Society of North America) and ANSI standards which define their photometric characteristics. To meet these standards, the lamps and fixtures are tested under laboratory conditions, and the results are reported as a manufacturer's rated values for lamp lumens, wattage, luminance and luminance performance. However, when comparing laboratory test results with actual field measurements, the results can differ. Such differences can be due to several variables such as manufacturing variations, arc tube alignment, lamp position, and field installation conditions, to name a few.

Manufacturing variations can directly affect the light output of the lamp. While each manufacturer develops their own set of tolerances that meet the IESNA and ANSI standards, the specifications themselves permit a certain amount of tolerance which leads to variations in light output and light distribution. Other problems may arise during luminaire assembly. For example, the lateral position of the lamp within the luminaire housing can vary, so that it is not centered within the optical system of the luminaire. Furthermore, the vertical position of the lamp is also critical, and lamps with different physical characteristics (i.e. size, dimension and shape of bulb), and ratings (i.e. wattage), require different vertical positions within the luminaire housing. To address the lateral and/or vertical positioning problem, most of the many different luminaire manufacturers employ some type of support mechanism to effect various lateral and/or vertical adjustment capabilities and methodologies.

Another factor affecting the photometric output of the lamp, is the number of arc tubes within the glass envelope. Typically, HID lamps have either one or two arc tubes. Lamps with a single arc tube, called ‘single-arc’ lamps, are the most prevalent. The major components of a single-arc lamp include a hermetically single alumina arc tube, a steel frame and its associated dome mount support which fixes the arc tube within a weather resistant glass envelope, a residue gas getter for collecting discharged gases within the vacuum tube; and the brass recording base for inserting the lamp into a socket. In general, single-arc lamps have a lifespan of approximately 20,000 hours of use before they need to be replaced.

Lamps having two arc tubes, referred to as ‘dual-arc’ lamps, are also available. A dual-arc lamp has the same components as a single-arc lamp with the exception that it contains two arc tubes are rather than one. For example, FIG. 1 shows, in simple and representative form, the components of a typical dual-arc lamp, including the second arc tube. The advantage of the dual-arc lamp is that the second arc tube results in almost double the lifespan of the single-arc lamp, or approximately 40,000 hours of use before replacement is required. The extended lifespan of the dual-arc lamp makes it preferable for use in luminaries, as it dramatically decreases the need for bulb replacement and maintenance costs over the lifetime of the lighting system in which it is deployed.

While the dual-arc lamp clearly has its advantages, it also has disadvantages. One disadvantage with the dual-arc lamp is related to its photometric distribution of the light. The single-arc lamp can be inserted (i.e. twisted, screwed or seated) into a socket with little concern regarding the final axial orientation of the arc tube. That is to say, the lamp can be axially rotated to any position within the socket, and the same lumen output pattern will result. In a dual-arc lamp, however, the final orientation of the two arc tubes when seated in a socket is very important.

A dual-arc lamp functions by cycling on and off between the two arc tubes; when one tube is on, the other is off. To ensure the resultant distribution pattern of the light from a dual-arc lamp is even regardless of which arc is on or off during operation, the two arc tubes are manufactured so that each arc tube is situated parallel to each other and are aligned in the same horizontal plane within the glass envelope. After installation into the socket, the axial orientation of the two arc tubes within the luminaire is crucial. When a dual-arc lamp is inserted into a socket it is important that both the arc tubes remain horizontally aligned, and as parallel to or co-planar as possible to the luminaire lens. When there is deviation from this alignment and orientation constraint, the resulting light distribution pattern will likely have undesirable directional effects or other optical aberrations (e.g. shadows) which negatively affects the overall lumen output.

Unfortunately, the adjustment of either the lamp or the lamp and socket together in combination is not easily facilitated. At present, the typical process is to manually align the dual-arc tubes by partially unseating, i.e., unscrewing the lamp from the corresponding socket. This approach, however, can be problematic as the electrical connection between the lamp or lamp base and socket may not be properly maintained which can create premature failures. While lateral and/or vertical adjustment mechanisms exist, practitioners have not successfully addressed the problem of the rotational or axial alignment or positioning of the lamp within the luminaire housing. Furthermore, it is a significant challenge to design a mechanism for axial adjustment which will interface with and/or couple to the plethora of available support brackets. Thus, while the extended life-span of the dual-arc lamp makes it attractive from a long term maintenance perspective, the alignment and adjustment considerations have hindered widespread adoption.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts in a simplified and representative form, an anterior or frontal exploded and perspective view of a mounting assembly with a lamp and lamp socket that is adjustable in accordance with one or more embodiments;

FIG. 2 depicts in a simplified and representative form, a posterior or rear exploded and perspective view of the FIG. 1 mounting assembly with a lamp and lamp socket that is adjustable in accordance with one or more embodiments;

FIG. 3 in shows a representative cross sectional view of the FIG. 1 mounting assembly and lamp socket as assembled in accordance with one or more embodiments;

FIG. 4 through FIG. 7 are representative diagrams of adjusting the mounting assembly of FIG. 1 so as to align a lamp in accordance with one or more embodiments;

FIG. 8 depicts in a simplified and representative form, an anterior or frontal exploded and perspective view of a mounting assembly with a lamp socket that is adjustable in accordance with one or more alternative embodiments;

FIG. 9 depicts in a simplified and representative form, a posterior or rear exploded and perspective view of the FIG. 8 mounting assembly with a lamp socket that is adjustable in accordance with one or more embodiments; and

FIG. 10 and FIG. 1 show representative views of alternative embodiments of a bracket that is a portion of the FIG. 1 (alternatively FIG. 8) mounting assembly in accordance with one or more embodiments.

### DETAILED DESCRIPTION

In overview, the present disclosure concerns mounting assemblies that are adjustable and configured to allow or provide for lamp alignment, e.g., angular or rotational alignment for a lamp socket and associated lamp or the like. More specifically various inventive techniques and apparatus for securing and adjusting or rotationally aligning or realigning lamps that are arranged and constructed for use in various environments, including severe outdoor environments will be discussed and disclosed.

The lamps that are of particular interest may vary widely but include dual arc HID (High Intensity Discharge) lamps. Dual arc HID lamps can be subject to extreme environments, including outdoor environments, over long periods of time and necessitate relatively exacting adjustments relative to an associated luminaire assembly in order to operate properly. In order to obtain the relatively long life expectancies that such lamps are capable of, these adjustments must be maintained over these life expectancies without otherwise adding new or contributing to existing failure modes. Thus, in systems, equipment and devices that employ dual arc HID lamps for illumination of large areas, e.g., street lighting systems, parking lot lighting systems, or indoor lighting systems, where the dual arc HID lamps must be properly rotationally or angularly aligned, the present apparatus and methods can be particularly advantageously utilized, provided they are practiced in accordance with the inventive concepts and principles as taught herein.

The instant disclosure is provided to further explain in an enabling fashion the best modes, at the time of the application, of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with mechanical components that may be fashioned using various fabrication technologies, e.g., metal stamping, forming, or various other metal working techniques. It is expected that one of ordinary skill, notwithstanding possibly significant effort and many design choices motivated by, for example, available time, current technology, and economic considerations, when guided by the concepts and principles disclosed herein will be readily capable of selecting appropriate fabrication technologies and generating or otherwise providing appropriate tooling to generate such components. Therefore, in the interest of brevity and minimization of any risk of obscuring the principles and concepts according to the present invention, further discussion of fabrication of such components, if any, will be limited to the essentials with respect to the principles and concepts of the various embodiments.

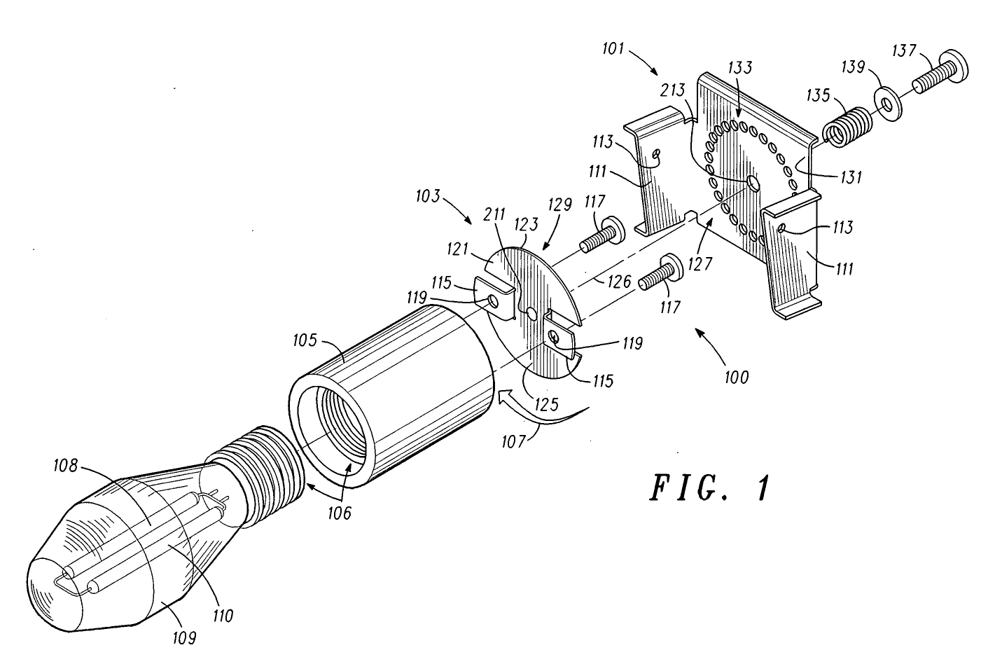

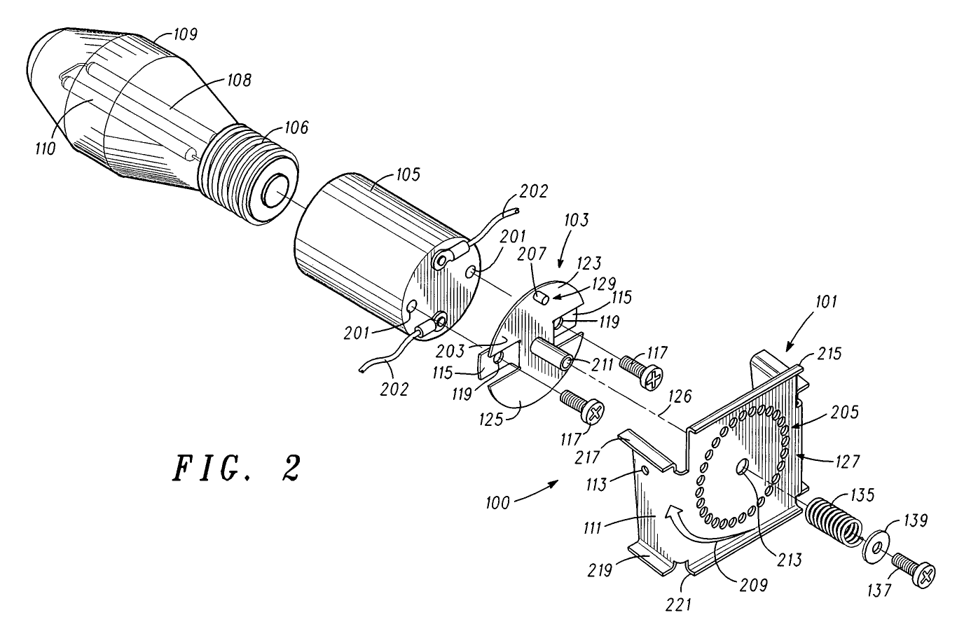

Referring to FIG. 1 and FIG. 2, exploded and perspective views of a simplified and representative mounting assembly 100 for a lamp 109 and associated lamp socket 105 that is adjustable (alternatively adjustable lamp socket assembly) in accordance with one or more embodiments will be briefly discussed and described. Once the lamp 109 is properly seated in the lamp socket 105, the mounting assembly 100 can be utilized to advantageously orient the lamp to an angular position that provides proper illumination of a target surface. FIG. 1 is an anterior or frontal view and FIG. 2 is a posterior or rear view of the mounting assembly 100. The mounting assembly of FIG. 1 and FIG. 2 includes a bracket 101 or positioning bracket and a mounting plate 103. The bracket 101 is configured (arranged and constructed) to be mechanically coupled to a generally known luminaire assembly (not shown). The mounting plate 103 is configured to mechanically couple, e.g., attach, to a lamp socket 105 and be mechanically coupled to the bracket 101 and to selectively engage the bracket at one of a multiplicity of angular rotations or rotational positions about axis 126 (angular rotations or positions generally depicted by arrow 107). The bracket 101 and mounting plate 103, in various exemplary embodiments, are formed via known metal stamping techniques, from, e.g., 0.050″ steel plate stock. Normally after forming, these elements are plated, e.g., zinc plated or the like, to provide a corrosion resistant finish.

The lamp socket is a standard generally known lamp socket which is adapted to secure, via a threaded interface 106 (threads on base of lamp mate with threads in the lamp socket), a lamp 109, e.g., dual arc HID lamp as shown. Note that in FIG. 1 and FIG. 2 some elements, e.g., the lamp 109 and lamp socket 105, are not necessarily to scale. Also as is known (generally shown at 202 in FIG. 2) the lamp socket in practice will have two electrical power leads attached to a surface, e.g., the rear or the side surface via screw and electrical terminal interfaces. A dual arc HID lamp is a lamp with, as the name suggests and as depicted, two arc tubes 108, 110. This lamp typically has a life expectancy that is approximately double a single arc HID lamp. This additional life expectancy is due to the fact that in operation only one of the arc tubes 108, 110 will be illuminated or activated at any one time. One reason that dual arc lamps are not more broadly adopted is the fact that the two tubes must be aligned to be essentially co-planer with what ever surface is being illuminated so that reasonably uniform illumination will result regardless of which tube is presently activated. Technicians often loosen the lamp in the lamp socket by un-screwing or un-seating the lamp 109 from the lamp socket 105 enough to rotationally position or align the lamp so that the two arc tubes are relatively co-planer with the surface of illumination. This unfortunately can contribute to poor connections between the lamp 109 and the lamp socket 105 and thereby contribute to reduced life expectancy or additional maintenance costs for the luminaire assembly.

Typically the bracket 101 will be secured or attached to a mounting arrangement (not specifically shown) (e.g., one or more metal elements) that provides a mechanical interface (direct or indirect) to a luminaire assembly. Ordinarily the lamp 109 will be adjusted vertically (higher or lower) or longitudinally (forward or backward) with respect to the reflector of the luminaire assembly. For example in various embodiments, the mounting arrangement (not specifically shown) is attached to the luminaire and includes some elements (not specifically shown) that are arranged for disposal adjacent to attachment members 111. These elements can have slotted openings that allow for longitudinal adjustment and some vertical adjustment via screws (not shown) that are secured to the attachment members 111 at holes 113. After appropriate adjustment, the bracket 101 and mounting arrangement are secured together by tightening the screws. The mounting arrangements and reflectors are generally known but vary widely with varying luminaire assemblies as provided by different manufacturers of such assemblies. Accordingly, it is expected that the attachment members 111 of the bracket 101 will also vary in form according to the luminaire assembly.

The mounting plate 103 in one or more embodiments is generally circular as shown with a first flange 123 and a second flange 125 and is further configured to rotate (relative to the bracket) together with the lamp socket 105 and lamp 109 about an axis 126. The mounting plate 103 in one or more embodiments, includes one or more socket tabs 115 that are configured to be coupled or attached to the lamp socket 105 using, e.g., threaded screws 117 that pass through openings 119 (e.g., 0.22″ diameter openings with centers spaced at 1.38″) in the socket tabs 115 and which are engaged or secured via threaded openings 201 (see FIG. 2) in a rear surface of the lamp socket 105. The socket tabs 115 are formed to be offset or recessed away from a front surface 121 of the mounting plate 103 and toward the lamp socket 105 by an amount that insures that the heads on the screws 117 do not extend beyond the mounting plate 103 or rear surface 203 thereof, thereby insuring that the mounting plate 103 can be mechanically coupled to the bracket 101 without any interference.

The bracket 101 further comprises a locking member 127 and the mounting plate 103 further comprises a complementary locking member 129, where the locking member 127 and complementary locking member 129 are configured to engage the mounting plate 103 and the bracket 101 at one of a multiplicity of angular rotations or positions when the bracket is disposed adjacent to the mounting plate, i.e., when the rear surface 203 is adjacent to a bracket surface 131, e.g., a front surface 131 of the bracket 101.

In some embodiments, the locking member 127 comprises a multiplicity of cavities (pockets, dimples, or the like) 133 disposed in the bracket 101 and the complementary locking member 129 further comprises one or more projecting members (bumps in the rear surface not specifically shown) that are configured for disposal in one or more of the multiplicity of cavities 133 to thereby engage the mounting plate 103 and the bracket 101. In other embodiments, the locking member 127 comprises a multiplicity of perforations (openings, apertures) 205 in or through the bracket 101 and the complementary locking member 129 further comprises a projecting member 207 that is configured for disposal within or through one of the multiplicity of perforations 205 to engage the mounting plate 103 and the bracket 101. It is noted that the pockets or perforations could be disposed in the mounting plate 103 with the complementary features (bumps, pins, etc.) disposed in the bracket 101. The multiplicity of perforations 205 in or through the bracket 101 in some embodiments further comprise a multiplicity of circular perforations (e.g., 0.175″ diameter circular openings) in the bracket and the projecting member 207 is a pin, e.g., circular or other cross sectional shaped pin, projecting from the mounting plate or rear surface 203 of the plate and configured for disposal within any one of the multiplicity of circular perforations 205. Note that the pin may be fashioned from separate stock of appropriate dimensions and the pin body can then be brazed or riveted or press fit to the mounting plate 101. The pin also may be formed from the same sheet stock that is used for the mounting plate by cutting out an appropriately located tab and then bending this tab to project from the rear surface 203 in one or more metal stamping operations. The pin formed by stamping operations is likely to have a rectangular cross section and in this case the multiplicity of perforations 205 would not necessarily need to be circular in form, although various practicalities may suggest a circular perforation.

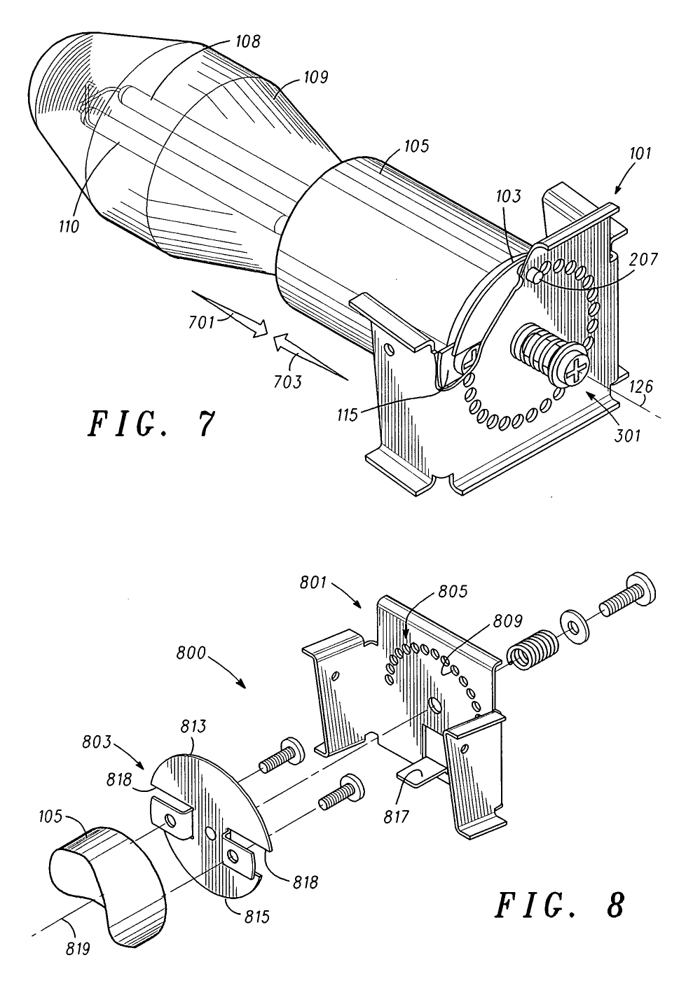

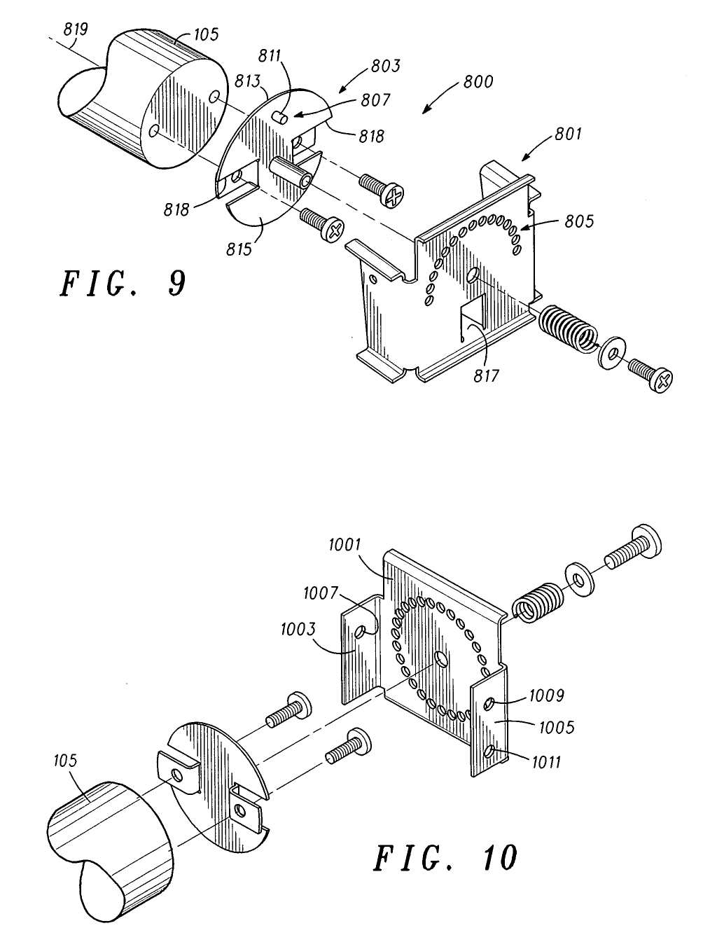

The multiplicity of cavities 133 or perforations 205 in the bracket 101 can be disposed in at least a portion of a arc 209 (e.g., circular arc with a 1.0″ radius each angularly spaced at nominally 12.8 degrees from adjacent perforations) as shown. The portion of the arc 209 generally needs to encompass a sufficient portion to account for the range of angular rotations or rotational positions that may be required in order to properly orient a dual arc lamp. In the embodiment depicted, this portion of an arc comprises a substantially full circle although other embodiments utilize substantially a half circle or slightly more than a half circle (see FIG. 8 and FIG. 9). Note that if the portion of the arc is or slightly exceeds 90 degrees, sufficient adjustment is provided to account for a worst case initial position of the dual arc lamp, i.e., it is desirable to have the two tubes 108, 110 of the lamp lying co-planer to the surface to be illuminated and the worst case initial position for these tubes is a plane that is perpendicular (90 degrees relative) to the desired plane.

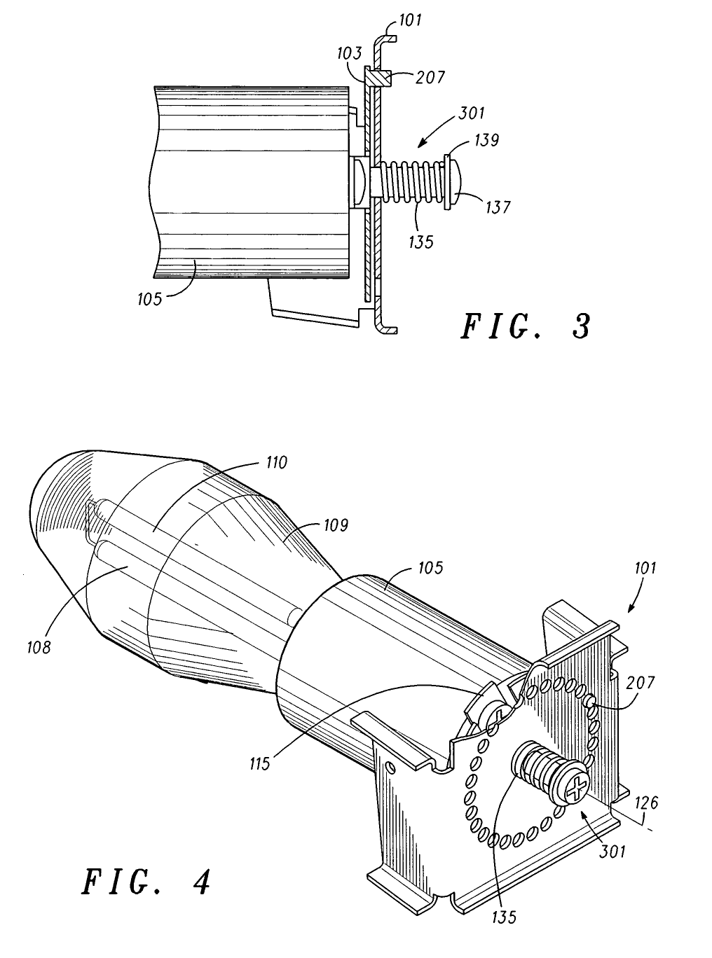

Referring additionally to FIG. 3, which shows a representative vertical cross sectional view of the FIG. 1 and FIG. 2 mounting assembly 100 with lamp socket 105 as assembled in accordance with one or more embodiments, additional features of the mounting assembly will be discussed and described. The mounting assembly further comprises an engaging structure 301 that is configured to secure the bracket 101 and the mounting plate 103 at any of the multiplicity of angular rotations, i.e., at the rotation or position where the projecting member 207 or pin passes through one of the multiplicity of perforations 205 (see FIG. 3). The engaging structure 301 further comprises a resilient member 135 that is configured (arranged, constructed, and disposed) to bias the mounting plate 103 toward the bracket 101. The engaging structure in various embodiments also comprises an axial body 211 (flush side shown in FIG. 1 and projecting side shown in FIG. 2) that is disposed and configured to facilitate rotational movement of the mounting plate 103 relative to the bracket 101. The axial body 211 in various embodiments is integral to the mounting plate 103 and the axial body is further configured for disposal through an opening 213 in the bracket 101. The engaging structure 301 can further comprise a spring or other resilient member, disposed about the axial body 211, where the spring is secured to the axial body with the bracket interposed between the spring and the mounting plate as shown. Other approaches for urging the mounting plate 103 toward the bracket 101 include the use of magnetic or electromagnetic structures (not specifically shown). Such structures may include a permanent magnet or electromagnetic body disposed, e.g., on a rear surface of the bracket 101 such that the mounting plate would be urged toward and held against the bracket until a rotational adjustment was indicated. As will be evident to those of ordinary skill, the electromagnetic body can obtain power from the same primary source as the HID lamp.

In the embodiment depicted, the axial body 211 is a circular body with an opening along an axis 126, where the inner surface of the opening is threaded. The axial body 211 can be separately formed with the appropriate opening machined and threaded with the resultant axial body brazed, press fit, or riveted to the mounting plate 103. A screw 137 is then disposed through a washer 139 and secured to the axial body 211 with the bracket and then the spring disposed about the axial body and secured between the mounting plate and the washer and screw. Thus as shown in FIG. 3, the mounting plate 103 is urged toward and is adjacent to the bracket 101 (rear surface 203 is adjacent to the bracket surface 131) when the locking member 127 and complementary locking member 129 are appropriately aligned, i.e., when the pin 207 is disposed in one of the multiplicity of perforations 205. Note, that a compressible pad with proper dimensions and durometer can be used rather than the spring, provided a material (e.g., elastomer tubing or the like) with appropriate lifetime and thermal or other environmental characteristics is selected.

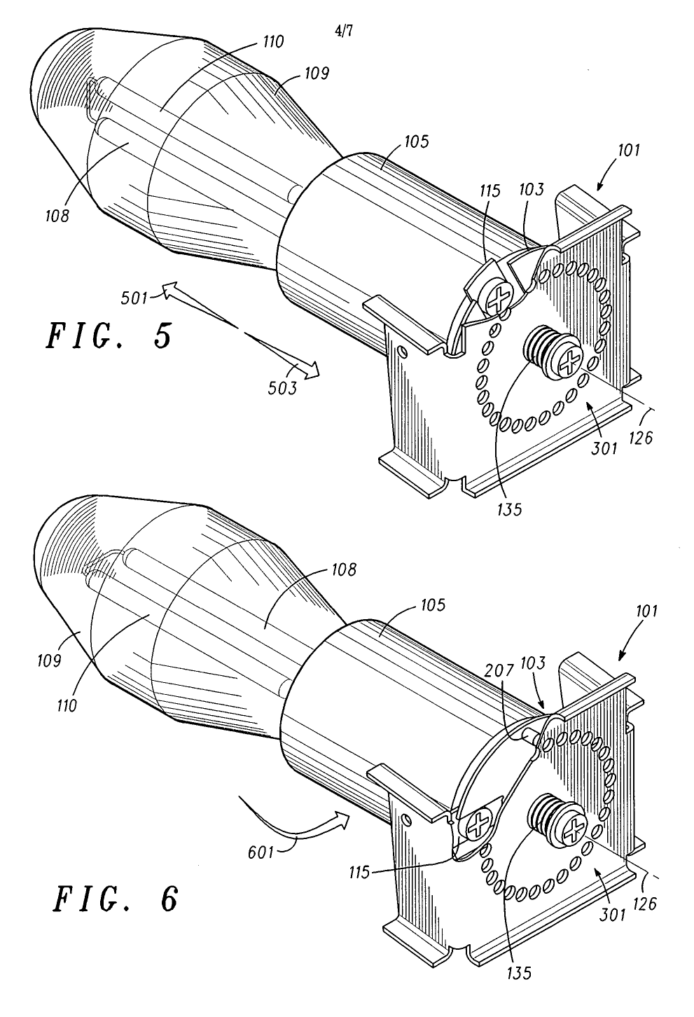

Thus as described and configured, the mounting assembly 100 (lamp relative to the bracket) can be rotationally adjusted since the mounting plate 103 and engaging structure 301, while mechanically coupled to the bracket 101, are configured to disengage the mounting plate 103 and the bracket 101 by applying sufficient pressure to the resilient member 135 (spring) so that the projecting member (pin) 207 is no longer disposed in one of the multiplicity of perforations 205. Then by merely rotating the mounting plate 103 (with lamp socket 105 and lamp 109) to another of the multiplicity of angular rotations, i.e., where the projecting member (pin) 207 is aligned with another perforation, and engaging the mounting plate 103 and bracket 101 at the other of the multiplicity of angular rotations by releasing the pressure on the projecting member (pin) 207, the pin is thus disposed in the other perforation (re-engage the locking member 127 and complementary locking member 129). This will be further described below with reference to FIG. 4-FIG. 7. In some embodiments, discussed below with reference to FIG. 8-FIG. 9, the mounting assembly 100 can include a limiting structure that is configured to limit angular rotation of the mounting plate 103 (and lamp socket with lamp) relative to the bracket 101. For example as depicted in FIG. 8-FIG. 9, the mounting assembly can include a limiting structure that further comprises a tab 817 that is integral to the bracket 801 and a flange 813 that is integral to the mounting plate 803, where the flange and tab are disposed to mechanically interfere when the angular rotation of the mounting plate relative to the tab exceeds predetermined limits. This limit feature can be useful to avoid undue stress on the power leads 202 that are attached, e.g., to the base, of the lamp socket 105 and could be overstressed if the mounting plate 803 were rotated about the bracket 801 by an excess amount, e.g., beyond 360 or 180 degrees.

The discussions above, with reference to FIG. 1, FIG. 2, and FIG. 3, have described various embodiments of an adjustable lamp socket assembly 100 that includes a lamp socket 105 that is configured to secure a lamp 109, a mounting plate 103 that can be mechanically coupled to the lamp socket and configured to rotate with the lamp socket about an axis 126, and a bracket 101 that is configured to mechanically couple to a luminaire assembly and further configured to selectively engage the mounting plate 103 at one of a multiplicity of rotational positions with respect to the bracket. The adjustable lamp socket assembly further includes means 301, disposed about the axis 126, for holding the mounting plate 103 and the bracket 101 at the one of the multiplicity of rotational positions.

The means for holding the mounting plate 103 and the bracket 101 can be described alternatively as comprising an annular body, e.g., the axial body 211, and a spring 135 or other resilient structure, disposed about the axis 126 and configured to urge the mounting plate toward the bracket, i.e., such that the mounting plate 103 and bracket 101 are disposed adjacent to one another as in FIG. 3. In various embodiments, the mounting plate 103 further comprises an integral annular body 211 disposed about the axis 126 and projecting from a surface (rear surface 203) of the mounting plate 103. The bracket further comprises an opening 213 arranged and configured such that the annular body 211 is disposed through the opening when the various elements or components are assembled. When assembled as in the depicted embodiment, the adjustable lamp socket assembly 100 further includes a resilient member, i.e., spring, 135 disposed over the annular body such that the bracket is interposed between the rear surface and the spring, with the spring secured via screw 137 and washer 139 to the annular body and configured to urge the mounting plate 103 toward the bracket 101.

The bracket in various embodiments further comprises a multiplicity of openings or perforations 205 disposed in a generally circular arc about the axis and the mounting plate further comprises a projecting member 207, pin or the like projecting from the mounting plate and configured to be disposed in one of the multiplicity of openings or perforations 205 (see FIG. 3) to secure the mounting plate 103 to the bracket 101 at any one of the multiplicity of rotational positions. As noted above, the bracket 101 further comprises one or more attachment members 111 that are configured to attach to the luminaire assembly (not shown). The bracket can also or optionally include as needed one or more strengthening bodies (folded ribs) 215, 217, 219, 221, etc. that are integral to the bracket and configured to increase rigidity or strength of the bracket. Selection of materials for the bracket with appropriate strength and rigidity characteristics may obviate any need for the folded ribs, etc.

Referring to FIG. 4-FIG. 7, an approach for adjusting or aligning the adjustable lamp socket assembly 100 will be shown and described. Using the mounting assembly or adjustable lamp socket assembly for proper angular adjustment, i.e., to correct a rotational alignment of the lamp that is incorrect as shown in FIG. 4, includes disengaging (FIG. 5) the mounting plate 103 and the bracket 101 by compressing the resilient member, i.e., spring, 135 and moving or sliding the mounting plate away from the bracket such that the projecting member, i.e., pin 207 is not disposed in one of the multiplicity of perforations 205 or openings, rotating (FIG. 6) the mounting plate to a new and desired position or rotational position, i.e., until the arc tubes are properly oriented with respect to an area of illumination, and re-engaging (FIG. 7) the mounting plate and the bracket by decompressing the spring and moving or sliding the mounting plate toward the bracket such that the projecting member, i.e., pin, 207 is disposed in a different one of the multiplicity of openings or perforations 205.

Beginning with FIG. 4, it can be observed that the lamp 109 is not properly aligned, i.e., one of the arc tubes is hidden by the other arc tube. Thus when arc tube 110 is activated, much of the light output can be blocked by arc tube 108. Alternatively, when arc tube 108 is activated much of the light from this tube can be blocked by arc tube 110. When one arc tube is blocking the light output from another it is likely that a target will not be properly illuminated. For this reason or others the level or uniformity of illumination will likely be different depending on which arc tube is illuminated. It will further be observed that the mounting plate 103 is engaged or rotationally fixed to the bracket 101 since the projecting member, i.e., pin, 207 is disposed through one of the perforations and furthermore the engaging structure 301, specifically spring, is in a somewhat relaxed position with possibly some preload. While the mounting plate 103 is not generally visible one of the socket tabs 115 can be seen and this tab has been rotated from the horizontal position depicted in FIG. 1-FIG. 3.

Thus a method of aligning (e.g., rotationally or angularly positioning) a lamp to a desired rotational position with respect to a luminaire, includes and begins with disengaging as depicted in FIG. 5, the mounting plate 103 (which is attached to lamp socket 105 with lamp 109 secured within the lamp socket) from the bracket 101 as shown by arrows 501, 503. Note that the mounting plate and the bracket are demountably coupled, e.g., as earlier described, about a common axis of rotation 126. Disengaging the mounting plate 103 and the bracket 101 in various embodiments further comprises compressing (e.g., by appropriately applying pressure) a resilient structure 135, e.g., compressing the spring (compressed as shown) and sliding or moving the mounting plate away from the bracket 101 as indicated by arrows 501 503. The sliding or movement of the mounting plate away from the bracket further comprises sliding or otherwise moving the mounting plate away from the bracket until projecting member, i.e., pin, 207 which is mechanically coupled or integral to the mounting plate is not disposed in any of a multiplicity of perforations 205 or openings in the bracket 101.

After disengaging the mounting plate 103 and bracket 101, the method of aligning includes rotating, as reflected in FIG. 6 by arrow 601, the mounting plate 103 about the common axis 126 of rotation to a rotational position corresponding to the desired rotational position of the lamp, i.e., to another one of the multiplicity of perforations 205 or openings in the bracket 101 that corresponds to a desired rotational position of the lamp 109. Note that the arc tubes 108, 110 are both equally visible and thus equally likely to provide nearly identical illumination to a target area. Furthermore the projecting member, i.e., pin, 207 is now located near the top perforation in the bracket 101.

After properly orienting, i.e., rotating the lamp, and as reflected in FIG. 7, the method of aligning the lamp 109 comprises re-engaging the mounting plate 101 and the bracket 103. Re-engaging the mounting plate and the bracket in various embodiments comprises de-compressing the resilient structure 135, e.g., decompressing the spring, and sliding or moving the mounting plate towards the bracket (see arrows 701, 703). The moving the mounting plate towards the bracket comprises sliding or repositioning the mounting plate towards the bracket until the projecting member, i.e., pin, 207 is disposed in one of the multiplicity of openings or perforations 205 as shown. While the method of aligning or orienting a lamp has been explained in terms of the apparatus of FIG. 1-FIG. 7, it will be evident to those or ordinary skill that other structures can be used to practice the method providing such structures include capabilities similar to the inventive concepts and principles taught herein.

Referring to FIG. 8 and FIG. 9, a simplified and representative diagram of an anterior or frontal (FIG. 8) and posterior or rear (FIG. 9) exploded and perspective view of a mounting assembly with a lamp socket 105 that is adjustable in accordance with one or more alternative embodiments will be discussed and described. FIG. 8 and FIG. 9 are, respectively, similar and analogous to FIG. 1 and FIG. 2 with much of the corresponding discussions being applicable to the mounting assembly of FIG. 8 and FIG. 9; however FIG. 8 and FIG. 9 show a bracket 801 and mounting plate 803 that include various unique features as compared to bracket 101 and mounting plate 103. For example, FIG. 8 and 9 show a mounting assembly 800 for a lamp socket 105 that is adjustable, where the mounting assembly includes a bracket 801 that is configured to be mechanically coupled to a luminaire assembly (not shown) and a mounting plate 803 that is configured to attach to the lamp socket and be mechanically coupled to the bracket and to selectively engage the bracket at one of a multiplicity of angular rotations.

The locking and complementary locking members 805, 807 are similarly configured in varying embodiments and similarly operate as described with reference to FIG. 1, to engage the mounting plate 803 and bracket 801 at any one of a multiplicity of angular rotations or rotational positions. FIG. 8 also shows the locking member comprising a multiplicity of pockets or perforations 809 and the complementary locking member comprising a projecting member (e.g., projecting pin 811) all operational as generally described with reference to FIG. 1, etc. However, the multiplicity of pockets or perforations 809 while disposed in a portion of a circular arc, are limited to a portion of an arc that is less that a full circle, e.g., in one embodiment substantially a half circle and in alternative embodiments (not shown) somewhere between a quarter (90 degrees) and substantially a half circle (180 degrees). One advantage of the embodiment of FIG. 8 and FIG. 9 arises from this limited degree of angular rotation given that electrical power leads in practice are attached to the rear or other surface of the lamp socket 105. By limiting the extent of the rotation or angular adjustment it is expected that excess wear or strain on the power leads can be avoided.

The mounting plate further comprises an integral first flange 813 and a second flange 815 that in one or more embodiments are disposed in a plane generally defined by the mounting plate. The bracket further comprises a limiting member 817 that is disposed and configured to interfere with the first flange 813, specifically at the outer portions of edges 818, and thus limit the mounting plate to rotational positions within defined limits. The limiting member 817 can be a tab that is formed and folded via metal stamping techniques so as to extend or project away from the bracket 801 and toward the mounting plate 803. In various embodiments at least a portion of the first flange 813 is formed with an outer edge having a larger radius than an outer edge of the second flange 815. With this arrangement and with the selection of proper dimensions and locations, the second flange 815 will clear the limiting member 817 during rotations of the mounting bracket about axis 819 while the first flange 813 (at least the outer portions of the edges 818 of the first flange 813) will interfere with the limiting member, i.e., tab, 817 and thus limit rotational positions about axis 819 of the mounting plate relative to the bracket to predetermined or defined limits, e.g., 180 degrees or other appropriate limitations.

In one exemplary embodiment the diameter of the first flange is 2.7″ while the second flange has an outer edge with a diameter of 2.25.″ In this instance the location of the limiting member 217 is nominally 1.14″ from the axis 819 and this member or tab is approximately 0.5″ in width. In one embodiment, the number of perforations is selected as 15 and these are angularly spaced at 12.857 degrees with a first perforation center on a horizontal line through the axis. With this arrangement a lamp can be oriented within +/−6.5 degrees of an optimum setting. If needed slight further angular adjustment of the lamp can be performed by adjusting the torque used to seat the lamp in the lamp socket.

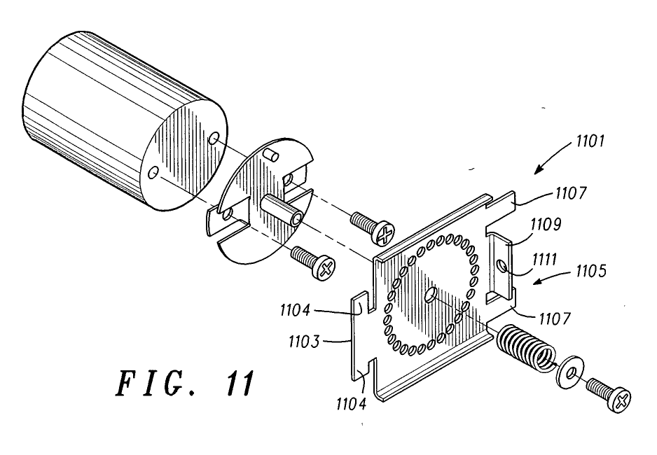

Referring to FIG. 10 and FIG. 11, representative views of alternative embodiments of a bracket 101 that is a portion of the FIG. 1 (alternatively 801 of FIG. 8) mounting assembly in accordance with one or more embodiments, will be discussed and described. As noted above various manufacturers utilize different mechanical interfaces between a lamp assembly and the corresponding reflector or luminaire assembly. In FIG. 10, a bracket 1001 with attachment members 1003 and 1005 is depicted. This bracket may be utilized to provide an adjustable mounting assembly embodying the inventive concepts and principles similar to the bracket 101. The bracket is similar to a bracket that is compatible with a luminaire provided by manufacturer Landmark. The attachment members 1003 and 1005 differ from attachment members 111. Attachment member 1003 is formed via known metal working or stamping techniques and is generally folded from the same material as the bracket 1001 and includes one opening 1007 for securing a screw to. Attachment member 1005 is similarly formed and includes two openings 1009 and 1011 for securing screws to.

FIG. 11 depicts a rear view of another embodiment of a bracket 1101 that is similar to a bracket that may be used to interface between the mounting assembly of FIG. 1-FIG. 11 and a luminaire or reflector assembly provided by Cooper. The bracket 1101 includes attachment members 1103, 1105. Attachment member 1103 as depicted includes a member disposed substantially in a plane and extending from a main body of the bracket as depicted. The member includes tabs 1104 that are spaced from the main body of the bracket. These tabs are suitable for disposition in a slotted opening in another mounting member (not shown). The attachment member 1105 includes extended tabs 1107 and a folded body 1109 with an opening 1109 for securing the bracket to the other mounting member of the luminaire assembly.

The mounting assemblies, mounting systems and methods, discussed above, and the inventive principles thereof are intended to and can alleviate various problems associated with the deployment of a luminaire that are inherent in prior art techniques. This is particularly so for a luminaire that utilizes a dual arc HID lamp or the like, where angular or rotational positioning is important for proper illumination. By providing a bracket that is suitable for mounting to a luminaire assembly and a separate mounting plate that is rotationally adjustable with respect to the bracket and thus luminaire, a lamp can be appropriately adjusted without running the risk of a lower quality higher maintenance electrical connection between the lamp and the lamp socket that may result when the lamp is backed out of the lamp socket. Thus it is expected that the convenient methods of adjusting the angular position of a dual arc HID lamp or the like as discussed and described herein will result in broader acceptance of such lamps as well as higher quality installations of these lamps with lower failure rates and more uniform illumination characteristics. These improvements should result in longer life expectancy and lower maintenance costs (lower overall costs) for many illumination systems.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A mounting assembly for a lamp socket that is adjustable, the mounting assembly comprising:
a bracket configured to be mechanically coupled to a luminaire assembly; and
a mounting plate configured to attach to the lamp socket and be mechanically coupled to the bracket and to selectively engage the bracket at one of a multiplicity of angular rotations.

2. The mounting assembly of claim I where the bracket further comprises a locking member and the mounting plate further comprises a complementary locking member, the locking member and complementary locking member configured to engage the mounting plate and the bracket at the one of a multiplicity of angular rotations when the bracket is disposed adjacent to the mounting plate.

3. The mounting assembly of claim 2 where the locking member comprises a multiplicity of cavities in the bracket and the complementary locking member further comprises a projecting member that is configured for disposal in one of the multiplicity of cavities to engage the mounting plate and the bracket.

4. The mounting assembly of claim 2 where the locking member comprises a multiplicity of perforations in the bracket and the complementary locking member further comprises a projecting member that is configured for disposal within one of the multiplicity of perforations to engage the mounting plate and the bracket.

5. The mounting assembly of claim 4 where the multiplicity of perforations in the bracket are disposed in at least a portion of an arc.

6. The mounting assembly of claim 5 where the at least a portion of an arc further comprises at least one of a substantially full circle, a substantially half circle, and a substantially quarter circle.

7. The mounting assembly of claim 4 where the multiplicity of perforations in the bracket further comprises a multiplicity of circular perforations in the bracket and the projecting member is a pin configured for disposal in any one of the multiplicity of circular perforations.

8. The mounting assembly of claim 1 further comprising an engaging structure configured to secure the bracket and the mounting plate at any of the multiplicity of angular rotations.

9. The mounting assembly of claim 8 where the engaging structure further comprises a resilient member configured to bias the mounting plate toward the bracket.

10. The mounting assembly of claim 8 where the engaging structure further comprises an axial body disposed and configured to facilitate rotational movement of the mounting plate relative to the bracket.

11. The mounting assembly of claim 10 where the axial body is integral to the mounting plate and the axial body is further configured for disposal through an opening in the bracket.

12. The mounting assembly of claim 11 where the engaging structure further comprises a resilient member disposed about the axial body, where the resilient member is secured to the axial body with the bracket interposed between the resilient member and the mounting plate.

13. The mounting assembly of claim 8 where the mounting plate and engaging structure, while mechanically coupled to the bracket, are configured to disengage the mounting plate and the bracket, rotate the mounting plate to another of the multiplicity of angular rotations, and engage the mounting plate and bracket at the other of the multiplicity of angular rotations.

14. The mounting assembly of claim 1 further comprising a limiting structure configured to limit angular rotation of the mounting plate relative to the bracket.

15. The mounting assembly of claim 14 where:
the limiting structure further comprises a tab that is integral to the bracket and a flange that is integral to the mounting plate, the flange and tab disposed to mechanically interfere when the angular rotation of the mounting plate relative to the flange exceeds predetermined limits.

16. An adjustable lamp socket assembly comprising:
a lamp socket configured to secure a lamp;
a mounting plate mechanically coupled to the lamp socket and configured to rotate with the lamp socket about an axis; and
a bracket configured to mechanically couple to a luminaire assembly and further configured to selectively engage the mounting plate at one of a multiplicity of rotational positions with respect to the bracket.

17. The adjustable lamp socket assembly of claim 16 further comprising means, disposed about the axis, for holding the mounting plate and the bracket at the one of the multiplicity of rotational positions.

18. The adjustable lamp socket assembly of claim 17 where the means for holding the mounting plate and the bracket further comprise an annular body and a spring disposed about the axis and configured to urge the mounting plate toward the bracket.

19. The adjustable lamp socket assembly of claim 16 where the bracket further comprises a multiplicity of openings disposed in a generally circular arc about the axis and the mounting plate further comprises a pin projecting from the mounting plate and configured to be disposed in one of the multiplicity of openings to secure the mounting plate to the bracket at any one of the multiplicity of rotational positions.

20. The adjustable lamp socket assembly of claim 19 where:
the mounting plate further comprises an integral annular body disposed about the axis and projecting from a surface of the mounting plate;
the bracket further comprises an opening with the annular body disposed through the opening; and
the adjustable lamp socket assembly further comprises a spring disposed over the annular body such that the bracket is interposed between the surface and the spring with the spring secured to the annular body and configured to urge the mounting plate toward the bracket.

21. The adjustable lamp socket assembly of claim 21 where a rotational alignment of the lamp includes disengaging the mounting plate and the bracket by compressing the spring and sliding the mounting plate away from the bracket such that the pin is not disposed in the one of the multiplicity of openings, rotating the mounting plate to a desired rotational position, and re-engaging the mounting plate and the bracket by decompressing the spring and sliding the mounting plate toward the bracket such that the pin is disposed in a different one of the multiplicity of openings.

22. The adjustable lamp socket assembly of claim 16 where:
the mounting plate further comprises an integral flange that is disposed in a plane defined by the mounting bracket; and
the bracket further comprises a limiting member disposed and configured to interfere with the integral flange and limit the mounting plate to rotational positions within defined limits.

23. The adjustable lamp socket assembly of claim 16 where the bracket further comprises one or more attachment members configured to attach to the luminaire assembly.

24. The adjustable lamp socket assembly of claim 16 where the bracket further comprises one or more strengthening bodies integral to the bracket and configured to increase rigidity of the bracket.

25. A method of aligning a lamp to a desired rotational position with respect to a luminaire, the method comprising:
disengaging a mounting plate attached to a lamp socket, the lamp secured within the lamp socket, from a bracket, where the mounting plate and the bracket are demountably coupled about a common axis of rotation;
rotating the mounting plate about the common axis of rotation to a rotational position corresponding to the desired rotational position of the lamp; and
re-engaging the mounting plate and the bracket.

26. The method of claim 25 where the disengaging the mounting plate and the bracket further comprises compressing a resilient structure and moving the mounting plate away from the bracket and the re-engaging the mounting plate and the bracket further comprises de-compressing the resilient structure and moving the mounting plate toward the bracket.

27. The method of claim 26 where the compressing the resilient structure further comprises compressing a spring and the decompressing the resilient structure further comprises decompressing the spring.

28. The method of claim 26 where:
the moving the mounting plate away from the bracket further comprises moving the mounting plate away from the bracket until a pin integral to the mounting plate is not disposed in any of a multiplicity of openings in the bracket; and
the moving the mounting plate toward the bracket further comprises moving the mounting plate toward the bracket until the pin is disposed in one of the multiplicity of openings.
